(19) United States
(12) Patent Application Publication
(10) Pub. No.: US 2005/0055474 A1
(43) Pub. Date: Mar. 10, 2005

(54) Monitor apparatus for computer system

(76) Inventor: Chien-Hsin Yang, Taipei City (TW)

Correspondence Address: Yi-Wen Tseng, 509 ROOSEVELT BLVD. #D306, FALL CHURCH, VA, 22044, US

(21) Appl. No.: 10/656,116

(22) Filed: Sep. 8, 2003

(51) Int. Cl. G06F 3/00

(52) U.S. Cl. 710/15

(57) ABSTRACT

A monitor apparatus for a computer system, by connecting a system management bus (SMBus) of a computer motherboard, operating information such as operating temperature, voltage and fan rotating speed related to operation of the computer system is directly obtained through hardware. The operation information is displayed on a screen of the monitor apparatus. Thereby, the user can control the computer system in a stable condition according to the data displayed on the screen. When the above voltage or temperature is abnormal, a warning signal is generated. For example, a light emitting diode (LED) may be switched on to flash, or an alarm may be triggered to generate a beep.

### BACKGROUND OF THE INVENTION

The present invention relates to a monitor apparatus for a computer system and, more particularly, to a monitor apparatus that provides real time system information related to operation of a computer system by hardware, so as to maintain the operation stability of the computer system.

Computers have been an inevitable device in modern society. How to provide a stable operation during the continuous application of the computer system is important. Only when the real time operation information is available, the user can properly use the computer system and resolves the abnormality to avoid system down.

The conventional way for monitoring the computer system is achieved by software. The user has to install the software into the computer first. Every time when the computer is booted, the software is executed to enter the system monitor program. The information related to the computer system such as operation temperature and voltage is then provided by the software. The drawback of the conventional monitoring way is that, for the desktop computer, the user has to install the software first, and such software has to be executed every time when the computer system is booted. The software seizures certain amount of the system resource, and thus affect the execution efficiency of the computer. In addition, for small size industrial computer, it is difficult to use the system monitor software to display the information without a proper monitor.

According to the above, the conventional way for monitoring the computer system is inconvenient to use and requires further improvement.

### BRIEF SUMMARY OF THE INVENTION

The present invention provides a monitor apparatus for a computer system implemented by hardware. Therefore, no monitor program needs to be executed for displaying system information of the computer system.

The monitor apparatus provided by the present invention comprises a hardware connected to a system management bus of a computer motherboard. The system information related to operation of the computer can thus be obtained directly via the system management bus. The hardware is also connected to various types of fans in the computer, including enclosure fan, CPU fan, and power supply fan to display the system information such as operating temperature, voltage, and fan rotation speed. The system information is displayed on a screen of the monitor apparatus. Thereby, the user can determine whether the computer system is under a stable operation condition according to the system information as displayed. When the above voltage or temperature appears to be abnormal, an alarm such as a light emitting diode (LED) is activated to generate a flash light, or an audio alarm is activated to generate a beep sound. Further, a multi-mode control of the fan can be executed by the monitor apparatus. By controlling the fan of the computer, low noise and constant temperature can be achieved. By connecting with the debug port of the motherboard, multi-lingual debug code can also be displayed on the panel of the monitor apparatus.

### BRIEF DESCRIPTION OF THE DRAWINGS

These, as well as other features of the present invention, will become apparent upon reference to the drawings wherein:

FIG. 1 is a block diagram showing a monitor apparatus connected to a computer system according to the present invention;

FIG. 2 shows a monitor apparatus installed in a computer system according to the present invention; and

FIG. 3 shows the control process of a monitor apparatus for a computer system according to the present invention.

### DETAILED DESCRIPTION OF THE INVENTION

To further distinguish the characteristics and technical contents of the present invention, a detailed description accompanied with the above drawings is provided. It is appreciated that the accompanying drawings are only exemplarily references and do not restrict or limit the scope of the present invention.

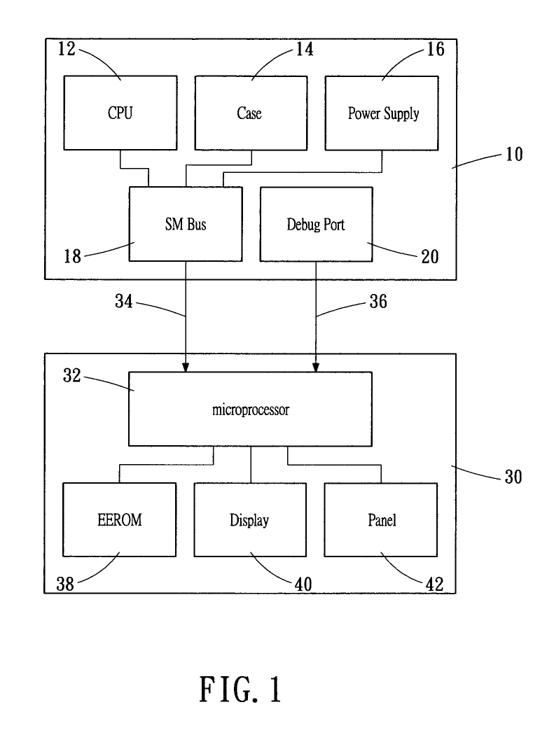

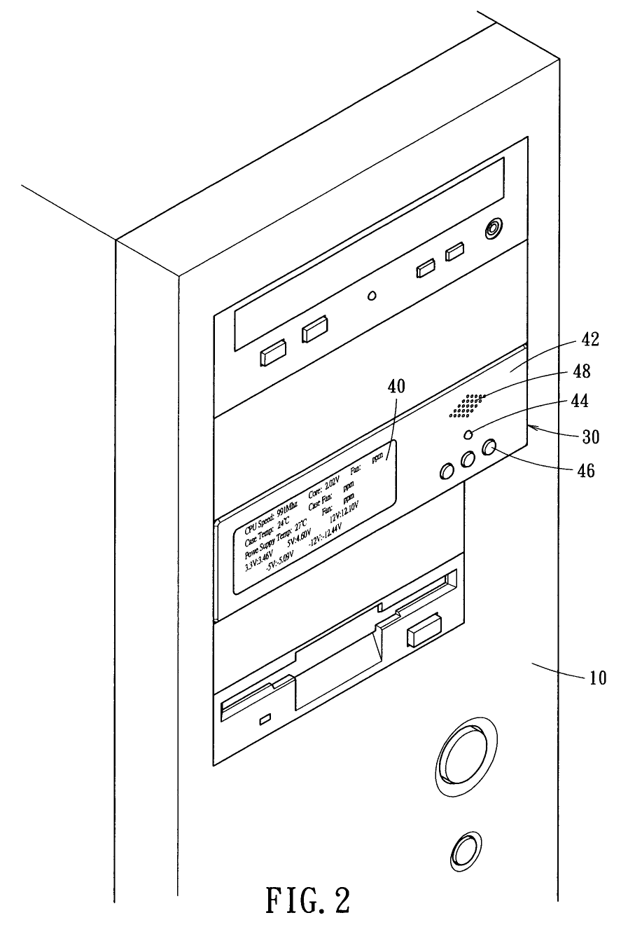

Referring to FIG. 1, a block diagram showing a monitor apparatus connected to a computer system is shown. The monitor apparatus 30 for a computer system includes a first microprocessor 32, a first input connection 34, a second input connection 36, an erasable memory 38, a display screen 40 and an operation panel 42. The computer host 10 connected to the monitor apparatus 30 comprises a central processing unit (CPU) 12, an enclosure 14, a power supply 16, a system management bus 18 and a debug port 20. The monitor apparatus 30 is installed in the computer host 10 as shown in FIG. 2.

The first connection 34 is connected to the system management bus (SMBus) 18 of the computer host 10. Under the control of the microprocessor 32, the operation information of the computer 10 is obtained. The operation information includes operation temperature, operation voltage and fan rotation speed. The SMBus is a common structure for current computer system, which allows some simple apparatus to transmit and receive signals for communicating apparatus via two interfaces. Therefore, in the present invention, the related information such as operating temperature and voltage of the CPU 12, the enclosure 14 and the power supply 16 of the computer host 10 can be obtained via the system management bus 18. Normally, heat dissipating fans are applied to the CPU 12, the enclosure 14 and the power supply 16. The rotation speed of these fans can be monitored via the system management bus 18. Further, a multi-mode control of these fans can be performed via the microprocessor 32 of the monitor apparatus 30. That is, according to the operation temperature information of the CPU 12, the enclosure 14 and the power supply 16, the rotation speed of these fans can be controlled to achieve low-noise and constant temperature operation. In addition, the second input connection 36 is connected to the debug port 20 of the computer host. By the control of the microprocessor 32 of the monitor apparatus, a debug code of the computer host 10 can be obtained and displayed on the screen 40 in desired language.

The erasable memory 38 includes an electrically erasable read only memory (EEROM), for example. Default operating temperature, voltage and fan rotation speed can be stored in the erasable memory 38 by the microprocessor 32. The screen 40 is operative to display the operating temperature, voltage and fan rotation speed obtained from the first input connection 34. The operation panel 42 as shown in FIG. 2 includes a display light 44 such as a light emitting diode (LED) and a plurality of buttons 46. By the control of the microprocessor 32, the buttons 46 are operated to enter a default mode for inputting the above default operation temperature, operation voltage and fan rotation speed. When the monitored operation temperature, operation voltage and fan rotation speed input by the first input connection 34 are larger than the default values stored in the erasable memory 38, the display light 44 may generate a warning signal, and/or the operation panel 42 may further includes a speaker 48 to generate a waning beep signal.

In FIG. 2, the monitor apparatus is installed in a slot of the computer host 10. A typically desktop computer is equipped several 3.5-inch and 5.25-inch slots. However, after installing the hard disk, compact disk drive, and floppy disk drive, some of the slots remain empty. The monitor apparatus provided by the present invention can thus be installed in the remaining empty slots. In addition, the small size industrial computer also has the slot design. Otherwise, the monitor apparatus can also be disposed external to the computer host.

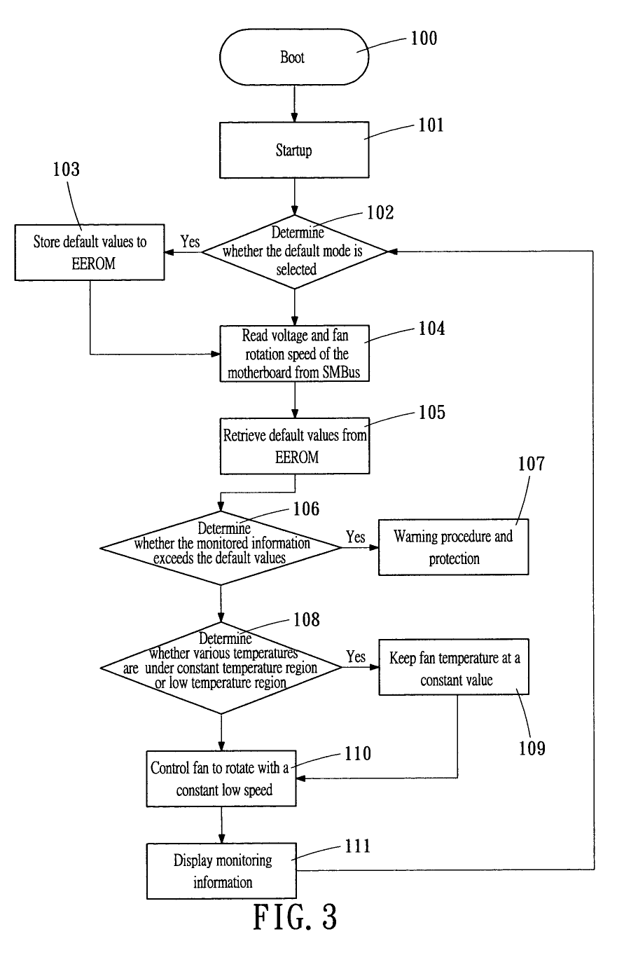

Referring to FIG. 3, the control process of the monitor apparatus is illustrated. As shown in step 100, the computer is booted. In step 101, a startup picture is displayed on the screen. Meanwhile, the computer is under operating status. The user can enter the default mode of the monitor apparatus 30 by operating the buttons on the operation panel 42. In step 102, whether the default mode is selected is determined. If the default mode is selected, the default values are stored in the EEROM 38 in step 103. Otherwise, system information such as temperature, voltage and fan rotation speed of the motherboard is read from the system management bus in step 104. In step 105, the default values stored in the EEROM are retrieved. In step 106, whether the monitored information exceeds the default values by a limit is determined. If the monitored information exceeds the default values over the limit, a warning procedure and protection of the motherboard are required in step 107. Otherwise, step 108 determines whether various temperatures are under the constant temperature region or low temperature region. Similarly, in step 109, the fan is controlled to keep the temperature at a constant value. Otherwise, in step 110, the fan controlled to rotate with a constant low speed. In step 111, the information as monitored is displayed on the screen 40.

This disclosure provides exemplary embodiments of a child safety blind. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. A monitor apparatus for monitoring system information during operation of a computer, comprising:
a microprocessor;
a first input connection, connected to a system management bus of a motherboard of the computer to obtain operation temperature, operation voltage and fan rotation speed of the computer;
an erasable memory, controlled by the microprocessor to store default values of operation temperature, operation voltage and fan rotation speed;
a display screen, controlled by the microprocessor to display the operation temperature, operation voltage and fan rotation speed obtained by the first input connection; and
an operation panel, comprising a display light and a plurality of buttons, controlled by the microprocessor to input the default values of operation temperature, operation voltage and fan rotation speed, wherein when the operation temperature, operation voltage and fan rotation speed obtained by the first input connection exceeds the default values, the display light generates a warning signal.

2. The monitor apparatus according to claim 1, wherein microprocessor is operative to control rotation speed of a fan in the computer to control operation temperature of the computer.

3. The monitor apparatus according to claim 1, further comprising a second input connection connected to a debug port of the computer, the second input connection being controlled by the microprocessor to obtain a debug code when an erred operation of the computer occurs, and to display the debug code on the display screen in a desired language.

4. The monitor apparatus according to claim 1, wherein the erasable memory includes an electrically erasable read only memory.

5. The monitor apparatus according to claim 1, wherein the display light includes a light emitting diode.

6. The monitor apparatus according to claim 1, wherein the operation panel further comprises a speaker to generate an audio warning signal when the operation temperature, operation voltage and fan rotation speed exceed the default values.
